(19) United States
(12) Patent Application Publication
(10) Pub. No.: US 2009/0262094 A1
(43) Pub. Date: Oct. 22, 2009

(54) ELECTROSTATIC DISCHARGE PROTECTION DEVICE FOR TOUCH PANELS

(75) Inventor: Chih-Chiang Lin, Taichung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: WINTEK CORPORATION, Taichung (TW)

(21) Appl. No.: 12/419,577

(22) Filed: Apr. 7, 2009

(30) Foreign Application Priority Data
Apr. 22, 2008 (TW) 097114576

(51) Int. Cl. G06F 3/045

(52) U.S. Cl. 345/174

(57) ABSTRACT

An electrostatic discharge protection device adapted for a touch panel, comprising: the touch panel, a flexible printed circuitboard and a plurality of point discharge structures. The touch panel is configured with a plurality of signal lines and at least a ground line while enabling the at least one ground line to be disposed along the circumference of an area enclosing the plural signal lines. The FPC has a plurality of signal lines and a ground line disposed outside an area relating to the plural signal lines for connecting the plural signal lines and the ground line to their corresponding signal lines and ground line of the touch panel. The plural point discharge structures are formed at positions between any two neighboring signal lines for guiding static accumulated on the touch panel to the ground line where it is discharged, by that the touch panel can be protected from ESD damage.

### FIELD OF THE INVENTION

The present invention relates to a touch panel, and more particularly, to an electrostatic discharge (ESD) protection device being substantially point discharge structures adapted for touch panels and flexible printed circuitboard (FPC).

### BACKGROUND OF THE INVENTION

With rapid advance of panel technology and popularization of electronic devices, there are more and more touch panels being used in various applications. The application of touch panel is rapidly becoming the trend for modern electronic devices.

Conventionally, a touch panel is a device capable of detecting the presence and location of a touch within its operating area. However, as the touch is usually enabled by the use of a finger, it is inevitable that the static existed in the finger will be transmitted to the touch panel and thus affect the performance of the integrated circuits embedded in the touch panel. For those integrated circuits in a touch panel that are designed to operate under several tens of Volts, such static can cause great damage to the LCD module and even to the driving units. The damage to the LCD module caused by the static discharging can be obvious and observable, which can cause defects on the panal, metal wires to melt, the components' resistacnes to change, damage or even breakage in the oxide layer, or even cause the micro processor or controller to operate erroneously. All the aforesaid damages will not only cause the lifespan of the touch panel to reduce greatly, but also will adversely affect the signal transmission raliablility of the touch panel.

### SUMMARY OF THE INVENTION

In view of the disadvantages of prior art, the object of the present invention is to provide an electrostatic discharge (ESD) protection device, capable of achieving a complete ESD protection in a touch panel by the use of at least a point discharge structures arranged between signal lines of the touch panel.

To achieve the above object, the present invention provides an electrostatic discharge (ESD) protection device adapted for a touch panel, which comprises: the touch panel, configured with a plurality of signal lines and a ground line while enabling the ground line to be disposed along the circumference of an area enclosing the plural signal lines; and a plurality of point discharge structures, formed correspondingly in pairs at positions between any two of the aforesaid signal lines that are neighboring to each other.

Moreover, the present invention further provides an electrostatic discharge (ESD) protection device adapted for a touch panel and a flexible printed circuitboard (FPC) connecting to the touch panel, which comprises: the touch panel, configured with a plurality of signal lines and a ground line while enabling the ground line to be disposed along the circumference of an area enclosing the plural signal lines; the FPC, configured with a plurality of signal lines and at least a ground line disposed outside an area relating to the plural signal lines in a manner that the plural signal lines and the at least one ground line are connected to their corresponding signal lines and ground line of the touch panel; and a plurality of point discharge structures, formed correspondingly in pairs at positions between any two of the aforesaid signal lines that are neighboring to each other.

It is noted that each pair of the point discharge structures in the ESD protection device is formed on their corresponding signal lines while none of which is disposed on the ground line, by that static current will only be dissipated to the plural signal lines through the point discharge structure pairs for achieving ESD protection.

The ESD protection device of the invention is adapted for protecting the circuit layout in touch panel and FPC from ESD damages, by that all the external static currents transmitted to the signal lines whenever and wherever the touch panel is touched will be guided to flow toward the outermost area of the panel where it is then being dissipated.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing an electrostatic discharge (ESD) protection device according to an embodiment of the invention.

FIG. 2 is a schematic diagram showing the point discharge structures formed in pairs according to a first embodiment of the invention.

FIG. 3 is a schematic diagram showing the point discharge structures formed in pairs according to a second embodiment of the invention.

FIG. 4 is a schematic diagram showing the point discharge structures formed on a flexible printed circuitboard according to an embodiment of the invention.

FIG. 5 shows a flexible printed circuitboard having two ends connecting respectively to a touch panel and a liquid crystal panel.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

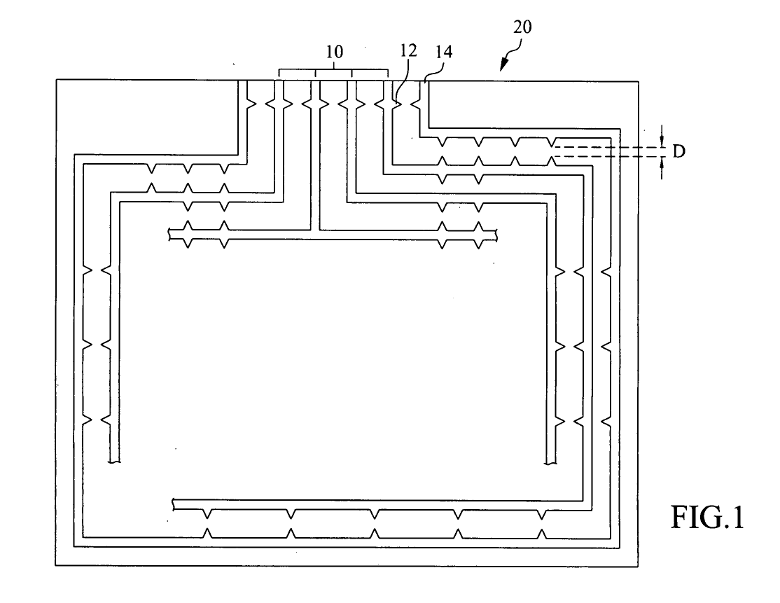

Please refer to FIG. 1, which is a schematic diagram showing an electrostatic discharge (ESD) protection device according to an embodiment of the invention. The touch panel 20 shown in FIG. 1 is a four-wire resistive touch panel, which is configured with four signal lines 10 and a ground line 14. the ground line is disposed surrounding an area enclosing the four signal lines 10 while disposing the two ends of the ground line 14 at positions relating to the outermost of the ends of the four signal lines 10. Moreover, there are a plurality of point discharge structures 12 being formed correspondingly in pairs at positions between any two of the aforesaid signal lines 10 that are neighboring to each other and also at positions between the ground line 14 and its neighboring signal lines 10.

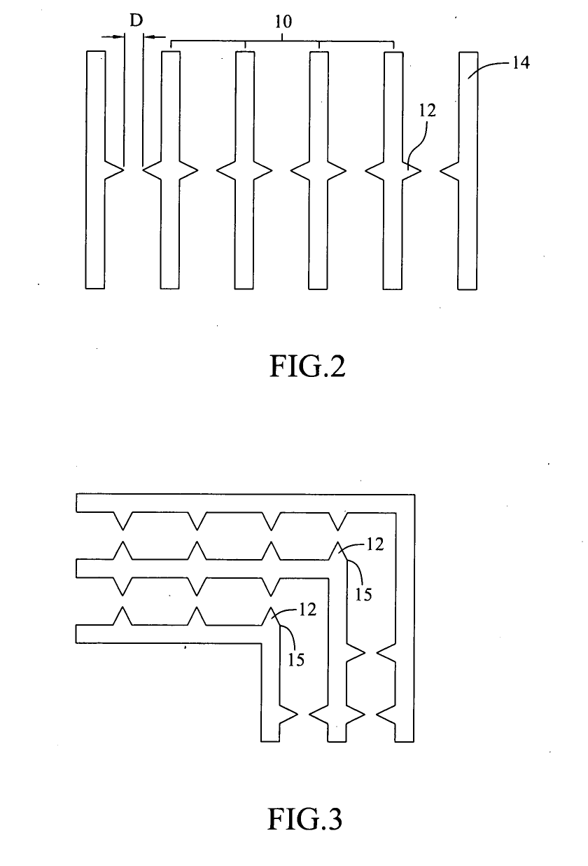

As shown in FIG. 1, the point discharge structures 12 formed on the signal lines 10 are formed in pairs in a manner that any two plural point discharge structures 12 of the same pair are formed respectively at two opposite sides of its corresponding signal line 10, while the point discharge structures 12 being formed on the ground line 14 are formed at a side thereof facing toward its neighboring signal lines 10. In another word, there are a number of the plural point discharge structures 12 being formed on the ground line 14 and there are a number of the plural point discharge structures 12 being formed on signal lines 10 at level positions thereof corresponding to those formed on the ground line 14, while defining any two point discharge structures having their tips facing toward each other as a pair. It is noted that the gaps between any two neighboring point discharge structures 12 of the same pair are formed with equal distance D, as shown in FIG. 2. In addition, the touch panel 20 of the invention can be a capacitive touch panel or a resistive touch panel, and when a resistive touch panel is adopted as the touch panel 20 of the invention, it can be a four-wire resistive touch panel or a five-wire resistive touch panel.

In FIG. 2, the point discharge structures 12 are formed in pairs at the two opposite sides of each signal line 10 in a symmetrical manner. On the other hand, the point discharge structures 12 of the same pair can be considered as the two point discharge structures 12 formed respectively and extrudingly at a position between the two neighboring signal lines 10 while enabling their tips facing toward each other as the plural point discharge structures 12 can be triangle-shaped structures of equal size or needle-like structures. Moreover, there are point discharge structures 12 formed in pairs between the ground line 14 and the signal lines 10 in a manner described as following: at a level position on the ground line 14 where there is formed with a point discharge structure 12, there will be point discharge structures formed on the signal lines correspondingly at the same level positions thereof, while enabling those point discharge structures formed on the ground line 14 to be disposed at a side thereof facing toward the area of the plural signal lines 10. Accordingly, by arranging any two neighboring point discharge structures whose tips are disposed facing toward one another as a pair, the gaps between any two neighboring point discharge structures 12 of the same pair are formed with equal distance D. It is noted that as static current can be transmitted from the tip of one point discharge structure 12 to the tip of another point discharge structure 12 of the same pair, static current will be guided to transmit to the ground line 14 in an inside-out manner.

Please refer to FIG. 3, which is a schematic diagram showing the point discharge structures formed in pairs according to a second embodiment of the invention. In FIG. 3, as each signal line 10 is bended at the right angle, there will be one point discharge structure being formed exactly on the right corner 15 at one of two perpendicular sides including the right corner 15.

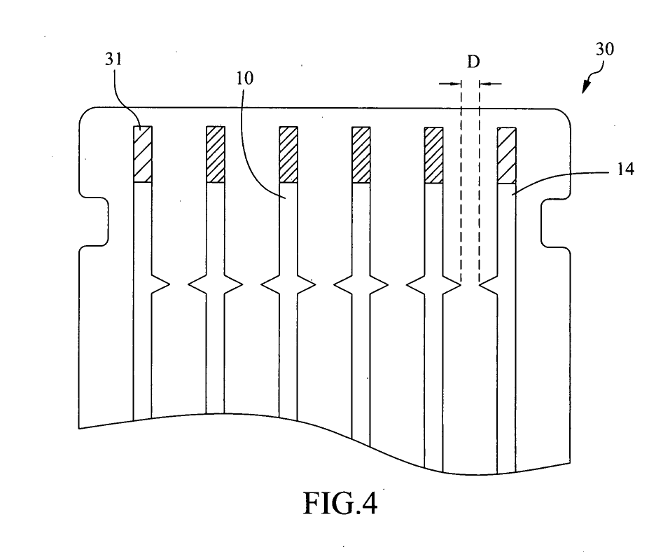

Please refer to FIG. 4, which is a schematic diagram showing the point discharge structures formed on a flexible printed circuitboard according to an embodiment of the invention. The flexible printed circuitboard 30 shown in FIG. 4 is configured with four signal lines 10 and a ground line 14 disposed either at the rightmost or the leftmost of the signal lines 10. Moreover, there are a plurality of point discharge structures 12 being formed correspondingly in pairs at positions between any two of the aforesaid signal lines 10 that are neighboring to each other and also at positions between the ground line 14 and its neighboring signal line 10. In Similarly, the gaps between any two neighboring point discharge structures 12 of the same pair are formed with equal distance D.

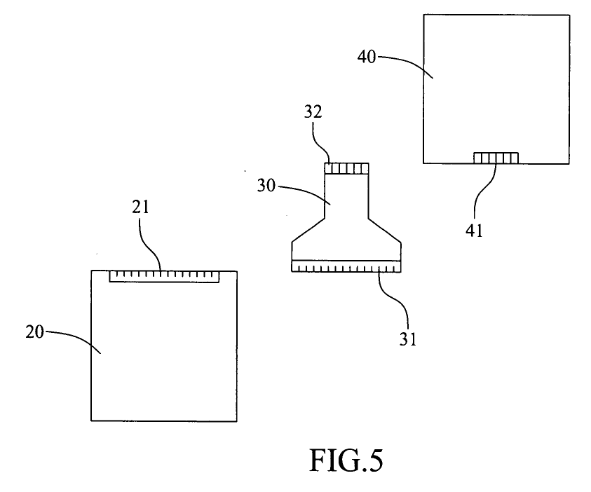

Please refer to FIG. 5, which shows a flexible printed circuitboard having two ends connecting respectively to a touch panel and a liquid crystal panel. In FIG. 5, the plural signal lines 10 and the ground line 14 embedded inside the flexible printed circuitboard 30 are connected to their corresponding signal lines 10 and ground line 14 of the touch panel 20. That is, the layout of the pin end 31 of the flexible printed circuitboard 30 should be designed to match with the connecting port layout of the touch panel 20 in a manner that the amount and layout positions of the signal lines 10 and ground lines 14 of the two should match with each other. Thereby, when the pin end 31 of the flexible printed circuitboard 30 is connected with the connecting port of the touch panel 30, static current in the touch panel 30 can be transmitted out of the same through the connection for minimizing the danger of ESD damage.

The electrical connection between the pin end 31 of the flexible printed circuitboard 30 and the connecting port 21 of the touch panel 30 can be enabled by the use of a conductive adhesive. In FIG. 5, another pin end 32 of the flexible printed circuitboard 30 is connected with the connecting port 41 of a liquid crystal panel 40.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An electrostatic discharge (ESD) protection device adapted for a touch panel, comprising:
the touch panel, configured with a plurality of signal lines and a ground line while enabling the ground line to be disposed along the circumference of an area enclosing the plural signal lines; and
a plurality of point discharge structures, formed correspondingly in pairs at positions between any two of the aforesaid signal lines that are neighboring to each other.

2. The electrostatic discharge protection device of claim 1, wherein there is a selected number of the plural point discharge structure pairs being formed correspondingly at positions between the ground line and its neighboring signal lines.

3. The electrostatic discharge protection device of claim 1, wherein the touch panel is a panel selected from the group consisting of: a capacitive touch panel and a resistive touch panel.

4. The electrostatic discharge protection device of claim 3, wherein the resistive touch panel is a panel selected from the group consisting of: a four-wire resistive touch panel and a five-wire resistive touch panel.

5. The electrostatic discharge protection device of claim 1, wherein the ground line is disposed surrounding the outermost circumference of the area enclosing the plural signal lines while enabling the two ends of the ground line to be located at positions relating to the outermost of the signal lines.

6. The electrostatic discharge protection device of claim 1, wherein the plural point discharge structures are triangle-shaped structures of the same size.

7. The electrostatic discharge protection device of claim 1, wherein the plural point discharge structures are needle-like structures.

8. The electrostatic discharge protection device of claim 1, wherein the plural point discharge structures are formed in pairs in a manner that any two plural point discharge structures of the same pair are formed respectively at two opposite sides of its corresponding signal line.

9. The electrostatic discharge protection device of claim 1, wherein there are a number of the plural point discharge structures being formed on the ground line at a side thereof facing toward the area of the plural signal lines.

10. The electrostatic discharge protection device of claim 1, wherein there are a number of the plural point discharge structures being formed on the ground line and there are a number of the plural point discharge structures being formed on signal lines at level positions thereof corresponding to those formed on the ground line, while defining any two point discharge structures having their tips facing toward each other as a pair.

11. The electrostatic discharge protection device of claim 1, wherein the plural point discharge structures are formed correspondingly in pairs at positions between any two of the aforesaid signal lines that are neighboring to each other and also at positions between the ground line and its neighboring signal lines.

12. The electrostatic discharge protection device of claim 10, wherein the gaps between any two neighboring point discharge structures of the same pair are formed with equal distance.

13. An electrostatic discharge (ESD) protection device adapted for a touch panel, comprising:
the touch panel, configured with a plurality of signal lines and at least ground line while enabling the at least one ground line to be disposed along the circumference of an area enclosing the plural signal lines;
a flexible printed circuitboard (FPC), configured with a plurality of signal lines and at least a ground line disposed outside an area relating to the plural signal lines in a manner that the plural signal lines and the at least one ground line are connected to their corresponding signal lines and ground line of the touch panel; and
a plurality of point discharge structures, formed correspondingly in pairs at positions between any two of the aforesaid signal lines that are neighboring to each other.

14. The electrostatic discharge protection device of claim 13, wherein there is a selected number of the plural point discharge structure pairs being formed correspondingly at positions between the ground line and its neighboring signal lines.

15. The electrostatic discharge protection device of claim 13, wherein the touch panel is a panel selected from the group consisting of: a capacitive touch panel and a resistive touch panel.

16. The electrostatic discharge protection device of claim 15, wherein the resistive touch panel is a panel selected from the group consisting of: a four-wire resistive touch panel and a five-wire resistive touch panel.

17. The electrostatic discharge protection device of claim 13, wherein the ground line is disposed surrounding the outermost circumference of the area enclosing the plural signal lines while enabling the two ends of the ground line to be located at positions relating to the outermost of the signal lines.

18. The electrostatic discharge protection device of claim 13, wherein the plural point discharge structures are triangle-shaped structures of the same size.

19. The electrostatic discharge protection device of claim 13, wherein the plural point discharge structures are needle-like structures.

20. The electrostatic discharge protection device of claim 13, wherein the plural point discharge structures are formed in pairs in a manner that any two plural point discharge structures of the same pair are formed respectively at two opposite sides of its corresponding signal line.

21. The electrostatic discharge protection device of claim 13, wherein there are a number of the plural point discharge structures being formed on the ground line at a side thereof facing toward the area of the plural signal lines.

22. The electrostatic discharge protection device of claim 13, wherein there are a number of the plural point discharge structures being formed on the ground line and there are a number of the plural point discharge structures being formed on signal lines at level positions thereof corresponding to those formed on the ground line, while defining any two point discharge structures having their tips facing toward each other as a pair.

23. The electrostatic discharge protection device of claim 13, wherein the plural point discharge structures are formed correspondingly in pairs at positions between any two of the aforesaid signal lines that are neighboring to each other and also at positions between the ground line and its neighboring signal lines.

24. The electrostatic discharge protection device of claim 13, wherein the gaps between any two neighboring point discharge structures of the same pair are formed with equal distance.

25. The electrostatic discharge protection device of claim 13, wherein the two ends of the FPC are connected respectively to the touch panel and a liquid crystal panel.
